(19) United States
(12) Patent Application Publication
(10) Pub. No.: US 2001/0011824 A1
(43) Pub. Date: Aug. 9, 2001

(54) Pipe-coupler system

(76) Inventor: Robert J. Davis, Plano, TX (US)

Correspondence Address: James E. Bradley, BRACEWELL & PATTERSON, P.O. Box 61389, Houston, TX, 77208-1389, US

(21) Appl. No.: 09/740,164

(22) Filed: Dec. 18, 2000

Related U.S. Application Data
(63) Continuation-in-part of application No. 09/314,290, filed on May 19, 1999, now abandoned.

(51) Int. Cl. F16L 17/00

(52) U.S. Cl. 285/371

(57) ABSTRACT

A pipe coupler is provided that is a non-metallic, cylindrical sleeve for connecting pipes that transport corrosive or abrasive fluids. The sleeve has grooves that are formed on the external surface of the fore and aft ends of the sleeve for receiving connector rings with internal grooves. Also, gaskets are used to seal the inner wall of the sleeve to the pipes. The gaskets may have a ribbed inner surface. The sleeve and connector rings receive the ends of two pipes to be connected. A tool is used to push the connector rings inward and onto the ends of the sleeve to cause grooves on the connector rings to engage the grooves on the ends of the sleeve. The gaskets in the connector rings compress against the external wall of each pipe to provide a seal against leaking.

### CROSS-REFERENCE TO RELATED APPLICATIONS

This application is a continuation-in-part from U.S. patent application Ser. No. 09/314,290, filed on May 19, 1999, entitled “Vacuum Coupler for Corrosive Applications.”

### BACKGROUND OF THE INVENTION

1. Technical Field

The present invention generally relates to fluid transportation systems and in particular to a system for connecting fluid transportation pipes.

2. Description of the Related Art

Dresser sleeves (pipe connectors) are commonly used at oil or gas well sites for pumping oil, gas and saltwater from a wellhead (the ground level portion of the well casing in a completed oil or gas well) to storage tanks. A wellhead manifold connects to pipe that, in turn, connects to storage tanks at the well site. In many installations, rather than pump the fluid under pressure to the storage tanks, a vacuum is pulled on the pipeline and the fluid is drawn, under vacuum, from the wellhead manifold through the pipeline to the storage tanks.

Saltwater, sulfur and other chemical compounds, which are corrosive to steel, are common in oil and gas wells. Saltwater is also used to pressurize oil and gas fields to enhance recovery efforts. In addition to the corrosive effects of salt water, hydrogen sulfide is a compound that is common in most, if not all, oil and gas well sites to some degree. Hydrogen sulfide combines with moisture or air in the oil or gas to produce corrosive compounds that are very destructive of steel pipe.

Transport of fluids (oil, gas, saltwater, etc.) to storage tanks at the well site is accomplished by using plastic pipe that is not subject to corrosion from saltwater or sulfuric acid. Even though the use of plastic pipe in the oil industry dates from the early 1940's, the standard connectors used to connect the lengths of plastic pipe are still manufactured using steel. The connectors are replaced frequently because of the corrosive effects of the saltwater and hydrogen-sulfide compounds on the steel connectors.

To combat corrosion on the current connectors, epoxy resins are used to coat the steel. This would probably be somewhat effective but for rocks, sand, and other abrasive materials contained in the fluid being transported. The abrasive materials break or wear down the protective epoxy coating to expose the bare steel to the corrosive fluid. Cost of replacement of the connectors is significant at each well site because of the number of connectors and the frequency of replacement of corroded and leaking epoxy-coated steel connectors.

### SUMMARY OF THE INVENTION

A pipe coupler is provided that is a non-metallic, cylindrical sleeve for connecting pipes that transport corrosive or abrasive fluids. The sleeve has grooves that are formed on the external surface of the fore and aft ends of the sleeve for receiving connector rings with internal grooves. Also, gaskets are used to seal the inner wall of the sleeve to the pipes. The gaskets may have a ribbed inner surface. The sleeve and connector rings receive the ends of two pipes to be connected. A tool is used to push the connector rings inward and onto the ends of the sleeve to cause grooves on the connector rings to engage the grooves on the ends of the sleeve. The gaskets in the connector rings compress against the external wall of each pipe to provide a seal against leaking.

### BRIEF DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a profile view of a pipe coupler with two plastic pipes inserted into the pipe coupler, the pipe coupler being constructed according to the present invention;

FIG. 2 is a perspective view of the pipe coupler depicted in FIG. 1.

FIG. 3 is a sectional view of a gasket according to the present invention;

FIG. 4 is a profile view of an installation tool according to the present invention; and

FIG. 5 is a profile view of a second embodiment constructed according to the present invention.

### DETAILED DESCRIPTION OF THE INVENTION

FIGS. 1 through 5 show a pipe-coupler system for connecting fluid transportation pipes.

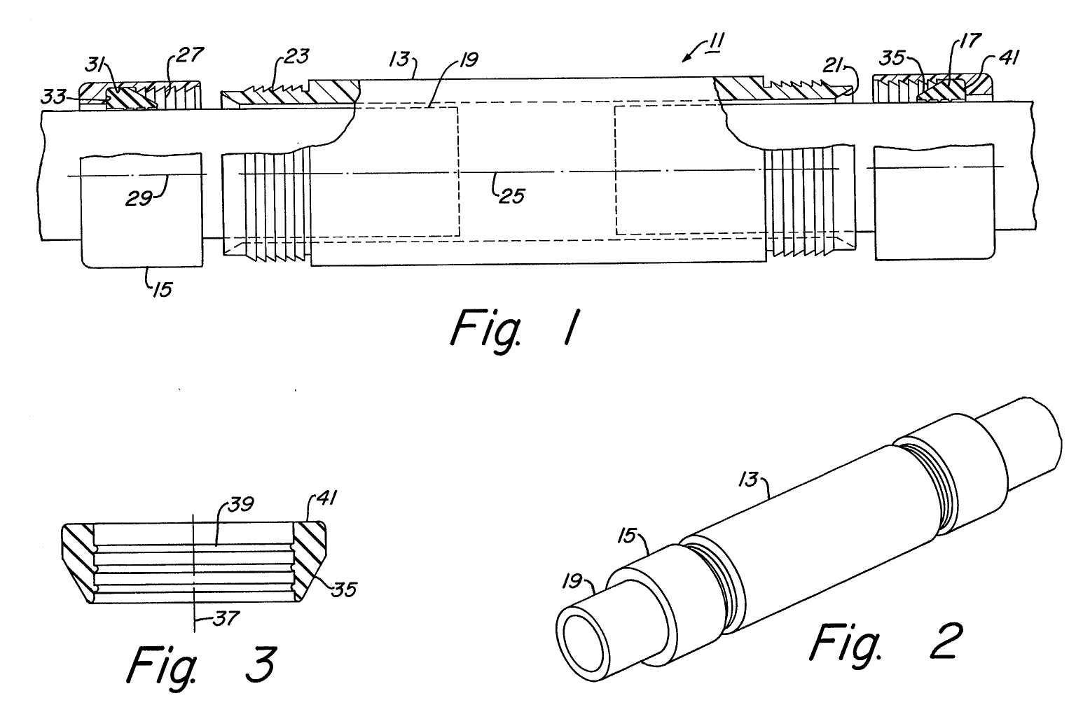

Referring to FIGS. 1 and 2, pipe coupler 11 comprises a sleeve 13, two connector rings 15, and two gaskets 17. Two sections of pipe 19 are inserted into the ends of sleeve 13, the pipes 19 being formed from plastic and used to transport corrosive or abrasive fluids. These fluids may be forced through the pipes 19 using pressure or pulled by a vacuum.

Sleeve 13 is a cylindrical tube preferably manufactured from extruded HDPE, or other hard plastic, with a wall thickness appropriate to the vacuum or pressure to be maintained in the pipes 19. The inner diameter of sleeve 13 is equal to or greater than the outer diameter of pipes 19. Each end of sleeve 13 is machined or formed to include a chamfered inner edge 21 and parallel, external grooves 23 on the external diameter near an outer portion of sleeve 13. Grooves 23 are perpendicular to the central axis 25 of sleeve 13 and are inclined about a circumference of sleeve 13 to produce a saw-tooth pattern. When engaged by corresponding grooves, the inclination allows for a component to be installed on each end of sleeve 13 by moving the component inward. However, the inclination prevents the component from moving in an outward direction. FIG. 2 is a perspective view of pipe coupler 11.

FIG. 1 shows connector ring 15, which is also preferably formed HDPE or other hard plastic. Ring 15 has parallel, internal grooves 27 located near an inner portion of ring 15 for engaging grooves 23 on sleeve 13. Grooves 27 are perpendicular to the central axis 29 of ring 15, and, like grooves 23, are inclined to form a saw-tooth pattern. A smooth, cylindrical bore 31 is adjacent grooves 27 and is sized for receiving gasket 17. The outer edge of bore 31 is defined by a shoulder 33 for retaining gasket 17 within ring 15 when ring 15 is installed onto sleeve 13. Gasket 17 is a preferably rubber ring having a wedge-shape cross-section, as shown in FIG. 3. Surface 35 of gasket 17 is angled inward relative to the central axis 37 of gasket 17. Gasket 17 may have ribs 39 on an inner diameter, as seen in the figure. A flat surface 41 abuts shoulder 33 of ring 15 (FIG. 1) when gasket 17 is installed in ring 15.

Referring again to FIG. 1, to install sleeve 13 for connecting two sections of pipe 19, gasket 17 is inserted into the smooth bore 31 of each connector ring 15, and the end of pipes 19 are inserted through the open ends of the ring 15-gasket 17 assemblies. The ends of pipes 19 are then inserted into the open ends of sleeve 13 to a desired depth within sleeve 13. Flat surface 41 abuts shoulder 33, which prevents gasket 17 from sliding out of the end of ring 15 Rings 15 are moved toward the ends of sleeve 13 until grooves 23 and grooves 27 begin to engage. Surface 35 of gasket 17 contacts chamfered inner edge 21 to form a seal between the inner diameter of sleeve 13 and surface 35. Ribs 39 of each gasket 17 contact the outer diameter of pipes 19 to form a seal between each gasket 17 and pipes 19. As rings 15 are moved farther inward, grooves 23 and 27 engage sequentially without rotation of rings 15, and the force between surface 35 and chamfered inner edge 21 and between ribs 39 and pipes 19 increases. This increases the sealing force in each of the sealing interfaces.

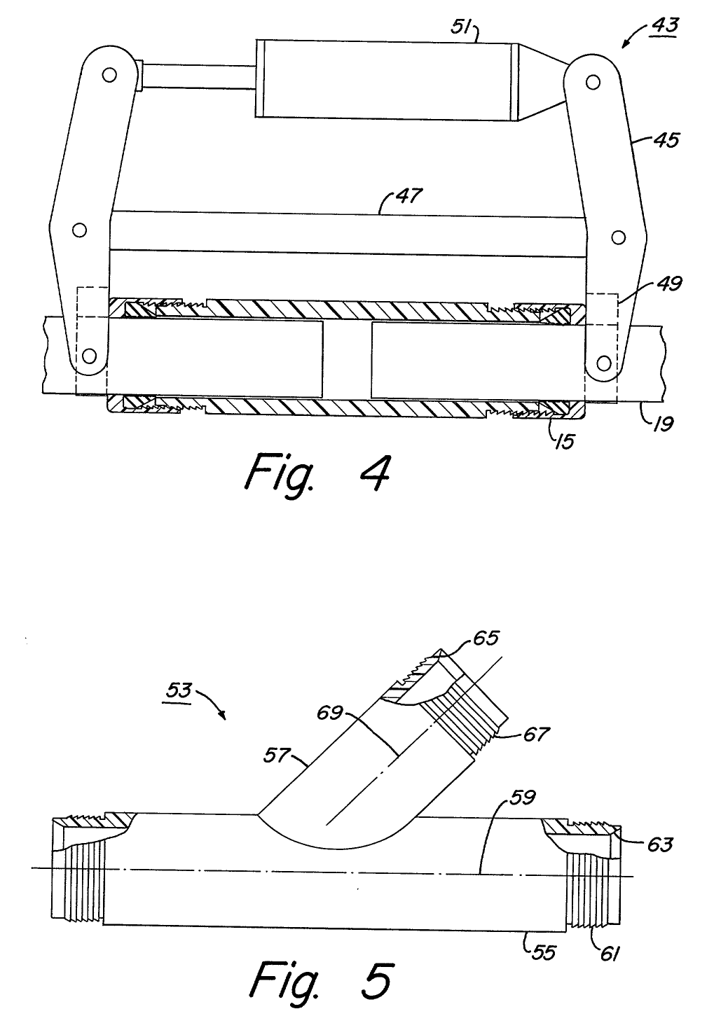

FIG. 4 shows an installation tool 43 for installing rings 15 onto sleeve 13. Tool 43 has two vertical legs 45 rotatably connected to a bar 47 near a middle portion of legs 45. A block 49 is rotatably connected to the lower end of each leg 45, the inner surface of each block 49 for engaging the outer end of each ring 15. Each end of a hydraulic ram 51, or similar device, is rotatably attached to the upper ends of legs 45. As ram 51 is extended, legs 45 rotate about each connection to bar 47, causing blocks 49 to engage rings 15. Blocks 49 push rings 15 onto the ends of sleeve 13 by applying a force directed inwardly along central axis 25 of sleeve 13. When rings 15 are moved to the desired position, ram 51 is retracted to move blocks 49 away from rings 15, and tool 43 can be removed.

Referring now to FIG. 5, a second embodiment of a pipe coupler 53 according to the present invention is depicted. A sleeve 55 is constructed in a similar manner as sleeve 13 (FIG. 1) but comprises a branch tube 57 extending from sleeve 55 at an angle relative to the central axis 59 of sleeve 55. Sleeve 55 has parallel, external grooves 61 on both ends for engaging grooves 27 of rings 15 (FIG. 1). As in the embodiment described above, grooves 61 are perpendicular to the central axis 59 of sleeve 55 Each end of sleeve 55 has a chamfered inner edge 63 for receiving a gasket 17. Like each end of sleeve 55, branch tube 57 also has a chamfered inner edge 65 and parallel, external grooves 67 for receiving internal grooves 27 of ring 15. Grooves 67 are perpendicular to the central axis 69 of branch tube 57 and are inclined relative to a circumference of branch tube 57.

The pipe coupler is a pipe-connecting device that is capable of resisting corrosion and abrasion, without failing, for an extended period of time. Current connectors are typically manufactured of steel and are subject to rapid deterioration when utilized with fluid transportation systems having a corrosive or abrasive environment. Most low-pressure systems use plastic pipe, but continue to use steel connectors, or dresser sleeves, to connect the pipe ends in the system. Steel connectors, even connectors that are epoxy coated, are replaced frequently, increasing system maintenance costs. Utilizing the pipe coupler of the present invention, a fluid transportation system will require replacement of connectors on a less frequent basis, producing cost savings in time, material and labor. The vacuum coupler is capable of operating in a vacuum or a pressurized state with no corrosion or deterioration over an extended period of time.

While the invention is shown in only two of its forms, it should be apparent to those skilled in the art that it is not so limited, but is susceptible to various changes without departing from the scope of the invention.

What is claimed is:

1. In a system for connecting a pair of fluid transport pipes, each pipe having an end, each end opposing the other end, the improvement comprising:
a non-metallic, tubular sleeve having open ends and parallel, external grooves on each end of the sleeve, the grooves being perpendicular to a central axis of the sleeve;
a pair of connector rings, each coupling one of the ends of the sleeve to one of the ends of one of the pipes, the rings having parallel, internal grooves that engage the external grooves on each end of the sleeve, the grooves of each ring being perpendicular to a central axis of each ring; and
a pair of gaskets, each for sealing an inner wall of the sleeve to an outer wall of each of the pipes.

2. The system of claim 1, wherein:
the sleeve has a minimum inner diameter that is equal to or greater than the outer diameter of each of the pipes.

3. The system of claim 1, wherein:
the gaskets frictionally retain the ends of the pipes within the sleeve.

4. The system of claim 1, wherein:
each gasket has ribs on an inner diameter of the gasket.

5. The system of claim 1, wherein:
each connector ring has an internal shoulder spaced from the internal grooves, and each of the gaskets abuts the shoulder for retaining the gasket within the ring.

6. The system of claim 1, wherein:
each gasket has a wedge-shaped outer diameter.

7. The system of claim 1, wherein:
the grooves of the sleeve and the grooves of the connector rings are inclined about a circumference of the grooves, the inclination providing for a saw-tooth pattern and preventing the rings from being displaced from the ends of the sleeve by a force directed in an outward direction along the central axis of the sleeve.

8. The system of claim 1, further comprising:
a branch tube for connecting a third pipe to the pair of pipes, the branch tube extending from a point between the ends of the sleeve and at an angle relative to the central axis of the sleeve, a first end of the branch tube being integral with the sleeve; and wherein
the branch tube has parallel, external grooves formed on a second end of the branch tube for engaging the grooves of the connector rings, the grooves of the branch tube being perpendicular to a central axis of the branch tube.

9. The system of claim 1, further comprising:
an installation tool having a pair of arms, each engaging an outer end of each connector ring and applying a force pushing the connector rings toward each other for causing the grooves on each of the connector rings to sequentially engage the grooves on one of the ends of the sleeve without rotation of the rings.

10. In a system for connecting a pair of fluid transport pipes, each pipe having an end and each end opposing the other end, the improvement comprising:
a non-metallic, cylindrical sleeve having open ends and parallel, external grooves on each end of the sleeve, the grooves being perpendicular to a central axis of the sleeve;
connector rings for coupling each end of the sleeve to an end of each of a pair of pipes, the rings having parallel, internal grooves for engaging the external grooves on each end of the sleeve, the grooves of each ring being perpendicular to a central axis of each ring, each ring having an internal shoulder and a smooth, cylindrical bore located between the shoulder and the internal grooves;
a pair of gaskets, each for sealing an inner wall of the sleeve to an outer wall of each of the pipes, each gasket having a wedge-shaped outer diameter and being located within the cylindrical bore; and
an installation tool having a pair of arms, each arm engaging an outer end of each connector ring and applying a force pushing the connector rings toward each other for causing the grooves on each of the connector rings to sequentially engage the grooves on one of the ends of the sleeve without rotation of the rings.

11. The system of claim 10, wherein:
the grooves of the sleeve and the grooves of the connector rings are inclined about a circumference of the grooves, the inclination providing for a saw-tooth pattern and preventing the rings from being displaced from the ends of the sleeve by a force directed in an outward direction along the central axis of the sleeve.

12. The system of claim 10, wherein:
the sleeve has a minimum inner diameter that is equal to or greater than the outer diameter each of the pipes.

13. The system of claim 10, wherein:
the gaskets frictionally retain the ends of the pipes within the sleeve.

14. The system of claim 10, wherein:
each gasket has ribs on an inner diameter of the gasket.

15. The system of claim 10, further comprising:
a branch tube for connecting a third pipe to the pair of pipes, the branch tube extending from a point between the ends of the sleeve and at an angle relative to the central axis of the sleeve, a first end of the branch tube being integral with the sleeve; and wherein
the branch tube has parallel, external grooves formed on a second end of the branch tube for engaging the parallel, internal grooves of the connector rings, the grooves of the branch tube being perpendicular to a central axis of the branch tube.

16. A method of connecting a pair of fluid transport pipes, the method comprising:
placing a connector ring over an end of each pipe, each of the rings having internal grooves that are perpendicular to a central axis of each ring;
inserting an end of each the pipes into a sleeve, the sleeve having open ends and parallel, external grooves on each end of the sleeve, the grooves being perpendicular to a central axis of the sleeve;
forcing the rings toward each other without rotation of the rings and causing the grooves of the rings to sequentially engage the grooves of each end of the sleeve; and
sealing an inner wall of the sleeve to an outer wall of each of the pipes.
